(19) United States
(12) Patent Application Publication
(10) Pub. No.: US 2014/0348704 A1
(43) Pub. Date: Nov. 27, 2014

(54) ANALYZING APPARATUS FOR LABORATORY TEST

(71) Applicants: CANON KABUSHIKI KAISHA, Tokyo (JP); CANON KASEI KABUSHIKI KAISHA, Ibaraki-ken (JP)

(72) Inventors: Masaaki Kobayashi, Kawasaki-shi (JP); Toshihiko Takahashi, Tsuchiura-shi (JP)

(73) Assignees: CANON KASEI KABUSHIKI KAISHA, Ibaraki-ken (JP); CANON KABUSHIKI KAISHA, Tokyo (JP)

(21) Appl. No.: 14/363,255

(22) PCT Filed: Nov. 29, 2012
(86) PCT No.: PCT/JP2012/081590

§ 371 Date: Jun. 5, 2014

(30) Foreign Application Priority Data
Dec. 9, 2011 (JP) 2011-270513

(51) Int. Cl. G01N 35/00

(52) U.S. Cl. CPC G01N 35/0092; G01N 2035/0094
USPC 422/67

(57) ABSTRACT

Provided is an analyzing program for a laboratory test, which stores a measurement program for concurrently processing inspection cartridges regarding all the combinations of prepared reaction and measurement patterns, the analyzing program causing an analyzing apparatus to execute the processes of reading the reaction and measurement patterns of the inspection cartridges in each of which one of the reaction and measurement patterns prepared in advance is provided, invoking a measurement program corresponding to a combination of the read reaction and measurement patterns, and performing reaction and measurement in accordance with the invoked measurement program.

### TECHNICAL FIELD

The present invention relates to an analyzing apparatus and program for a laboratory test, for concurrently processing multiple inspection cartridges of which reaction and measurement times and steps are predetermined.

### BACKGROUND ART

A laboratory test has been widely performed, which serves to grasp a physical condition and to diagnose diseases by analyzing a sample collected from a human or an animal, analyzing components of the sample through a biochemical inspection, an immunological inspection, a hematological inspection, or a microbiological inspection, and checking the presence/absence of a germ in the sample. The laboratory test has various purposes, and multiple kinds of inspections are often performed concurrently with respect to the same analyte.

For example, in the field of In-Vitro diagnostics for determining a trace amount of components in an analyte such as blood of a human, an immunological measurement method using an antigen-antibody reaction has been widely used. The immunological measurement method is roughly classified into a homogeneous measurement method and a heterogeneous measurement method, and further, can be classified into a competitive measurement method and a non-competitive measurement method.

In the competitive measurement method, when antigens in an analyte bind to antibodies, the antigens react with labeled antigens competitively, and the amount of the labeled antigens which bind to the antibodies is measured. According to this method, the concentration and signal value of the antigens in the analyte are inversely proportional to each other.

On the other hand, the non-competitive measurement method is also called a sandwich method, and according to this method, antigens in an analyte bind to antibodies, and labeled antibodies further bind to the antigens. Then, the amount of the labeled antibodies which bind to the antigens is measured. In this method, the concentration and signal value of the antigens in the analyte are proportional to each other.

The above-mentioned immunological measurement method is often used for an inspection cartridge used in an analyzing apparatus for a laboratory test. However, a wide variety of measurement methods, reaction and measurement times, and steps are selected in an inspection cartridge, often depending on the purposes of an inspection. For example, in the case where the concentration of an analyte to be measured is low, the sandwich method is used. Further, in the case where a molecular weight to be measured is small, the competitive measurement method is used. Further, various insoluble carriers, such as a well-shaped carrier, a stick-shaped carrier, or a microsphere, are used in the homogeneous measurement method, and selected in accordance with the number of inspection items, the reaction time, and the simplicity of an operation. In addition, an operation of mixing a reaction solution may be performed so as to enhance reaction efficiency.

On the other hand, in order to continuously measure multiple inspection items, a method of concurrently processing multiple inspection cartridges having different reaction and measurement times and steps has been proposed.

As described above, in an inspection cartridge, reaction and measurement times and steps are determined depending on the purposes of an inspection. Therefore, in order to efficiently measure multiple inspection cartridges subjected to different processing, in general, a measurement schedule of the inspection cartridges to be processed continuously is arithmetically processed and determined in advance.

For example, Patent Literature 1 proposes an analyzing system scheduling method of allocating, before start of measurement, each reaction and measurement step of inspection cartridges to be measured continuously to a time schedule, determining an execution order, an execution time, and an execution interval, and determining a measurement schedule.

### CITATION LIST

### Patent Literature

PTL 1: Japanese Patent No. 3803936

### SUMMARY OF INVENTION

### Technical Problem

In the analyzing system scheduling method of arithmetically processing and determining a measurement schedule of inspection cartridges to be continuously measured before start of measurement, there has been a problem in that the amount of information to be dealt with in the determination of the measurement schedule is large, and it takes too much time for determining the measurement schedule.

Further, in a small analyzing apparatus for a laboratory test aiming at a Point-of-care testing, it has been difficult to mount a complicated program for the reasons of reduction in size of the apparatus, simplification, reduction in cost, etc.

### Solution to Problem

The present invention provides an analyzing apparatus and program for a laboratory test, for concurrently processing multiple inspection cartridges in which reaction and measurement times and steps are determined. The present invention provides an analyzing apparatus for a laboratory test, which is configured to concurrently process multiple inspection cartridges each having a reaction and measurement pattern formed of a combination of a reaction and measurement time and a step, the analyzing apparatus including: at least one of a transport unit, a dispensing unit, and a measuring unit, the at least one of the transport unit, the dispensing unit, and the measuring unit being shared among the multiple inspection cartridges; a placement region for the multiple inspection cartridges; a measurement program storing unit configured to store a measurement program for concurrently processing the multiple inspection cartridges so that the at least one unit shared among the multiple inspection cartridges is not used simultaneously by the multiple inspection cartridges, regarding all combinations of prepared reaction and measurement patterns; a reaction and measurement pattern collecting unit configured to read the reaction and measurement patterns of the multiple inspection cartridges; an arithmetic processing unit configured to invoke a measurement program corresponding to a combination of the read reaction and measurement patterns; and a measurement unit having a mechanism configured to perform reaction and measurement in accordance with the measurement program.

Further, The present invention provides an analyzing program for a laboratory test, for concurrently processing multiple inspection cartridges each having a reaction and measurement pattern formed of a combination of a reaction and measurement time and a step in an analyzing apparatus for a laboratory test, the analyzing apparatus including at least one of a transport unit, a dispensing unit, and a measuring unit, and a placement region for the multiple inspection cartridges, the at least one of the transport unit, the dispensing unit, and the measuring unit being shared among the multiple inspection cartridges, the analyzing program storing a measurement program for concurrently processing the multiple inspection cartridges so that the at least one unit shared among the multiple inspection cartridges is not used simultaneously by the multiple inspection cartridges, regarding all combinations of prepared reaction and measurement patterns, the analyzing program causing the analyzing apparatus to execute the processes of: reading the reaction and measurement patterns of the multiple inspection cartridges in each of which one of the reaction and measurement patterns corresponding to various reaction and measurement times and steps prepared in advance is provided; invoking a measurement program corresponding to a combination of the read reaction and measurement patterns; and performing reaction and measurement in accordance with the invoked measurement program.

### Advantageous Effects of Invention

According to the analyzing apparatus for a laboratory test of the present invention, it is not necessary to arithmetically process a complicated measurement schedule before start of measurement, and it is possible to make an efficient measurement merely by invoking the measurement program corresponding to the combination of the inspection cartridges to be measured concurrently. A program used for determining the measurement schedule is also simple, and hence the present invention can also be applied as an analyzing program for a small analyzing apparatus for laboratory test aiming at a point-of-care testing.

Further features of the present invention will become apparent from the following description of exemplary embodiments with reference to the attached drawings.

### BRIEF DESCRIPTION OF DRAWINGS

FIG. 1 is a conceptual diagram illustrating a configuration of an analyzing apparatus in a first embodiment of the present invention.

FIGS. 2A and 2B are conceptual views of an inspection cartridge in an analyzing apparatus for a laboratory test of the present invention.

FIGS. 3A, 3B, and 3C are conceptual diagrams of measurement programs in the analyzing apparatus for a laboratory test of the present invention.

FIG. 4 is a flowchart illustrating an operation example of an analyzing apparatus in a second embodiment of the present invention.

FIG. 5 is a flowchart illustrating an operation example of an analyzing apparatus in a third embodiment of the present invention.

FIG. 6 is a conceptual diagram illustrating a configuration of an analyzing apparatus in a fourth embodiment of the present invention.

FIG. 7 is a flowchart illustrating an operation example of the analyzing apparatus in the fourth embodiment of the present invention.

FIGS. 8A and 8B are conceptual diagrams of an analyzing program for a laboratory test in a fifth embodiment of the present invention.

FIG. 9 is a conceptual view of a measurement unit in an analyzing apparatus for a laboratory test of the present invention.

### DESCRIPTION OF EMBODIMENTS

An analyzing apparatus and a program for a laboratory test according to embodiments of the present invention are described in detail hereinafter with reference to the drawings. Note that, the embodiments described below are merely examples, and the present invention is not necessarily limited thereto.

### First Embodiment

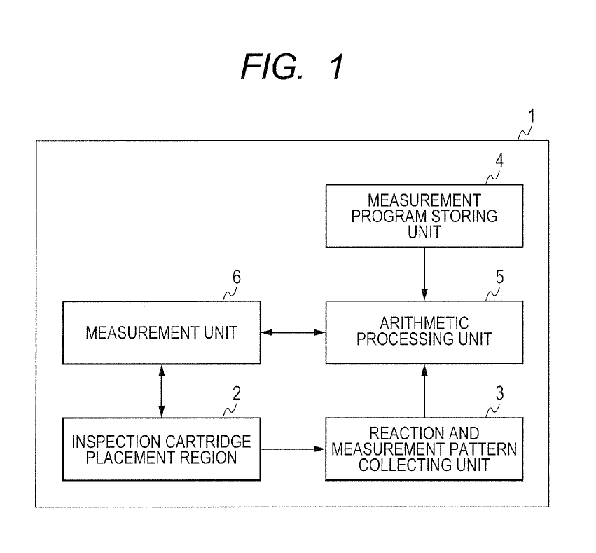

FIG. 1 is a conceptual diagram illustrating a configuration of an analyzing apparatus of a first embodiment of the present invention. An analyzing apparatus 1 of the first embodiment is an apparatus for a laboratory test, which is configured to concurrently process, in any combination, multiple inspection cartridges, in which reaction and measurement times and steps are predetermined. At least one of a transport unit, a dispensing unit, and a measuring unit is shared among the inspection cartridges. The analyzing apparatus for a laboratory test includes a measurement program storing unit 4 configured to store a measurement program for concurrently processing inspection cartridges in all the combinations of prepared reaction and measurement patterns, a reaction and measurement pattern collecting unit 3 configured to read a reaction and measurement pattern of the inspection cartridge provided with one of the reaction and measurement patterns corresponding to the various reaction and measurement times and steps prepared in advance, a placement region 2 for placing the inspection cartridge, an arithmetic processing unit 5 configured to invoke a measurement program corresponding to a combination of the read measurement pattern, and a measurement unit 6 configured to perform reaction and measurement in accordance with the invoked measurement program.

Concurrently processing inspection cartridges as used herein refers to that multiple inspection cartridges can be processed in the same analyzing apparatus, and at that time, both of reaction and measurement patterns of two or more inspection cartridges may be performed at a moment.

The inspection cartridge in the analyzing apparatus for a laboratory test of the present invention is a cartridge to be incorporated for use into an analyzing apparatus aiming at measuring a substance to be inspected in an analyte, and it includes at least a reaction tank provided for performing a reaction necessary for measuring the substance to be inspected. A storage tank may be provided in the inspection cartridge to be filled with a reagent required for measurement in advance. Alternatively, the reaction tank or the storage tank may be filled with a reagent later through the dispensing unit or the like.

There is no particular limit to a shape of the inspection cartridge, as long as a substance to be inspected can be measured. Examples of the inspection cartridge include a boat-shaped cartridge in which multiple reaction tanks and storage tanks are arranged, and a flow channel type cartridge in which a groove is provided in a plate-shaped base and the reaction tank and the storage tank are connected through a flow channel. Although there is no particular limit to a size of the cartridge, if the size of the cartridge is small, the cartridge can be suitably incorporated into and used in the analyzing apparatus.

In order to prevent mixing of foreign matters into the reaction tank of the inspection cartridge, and evaporation and degradation of a reagent filled in the storage tank, an upper part of each tank can be sealed. For example, there is a method of bonding an aluminum foil, a polymer thin film, or the like to upper parts of the reaction tank and the storage tank of the cartridge. In particular, it is preferred to seal the upper part of each tank with an aluminum foil because the seal can be easily opened with a perforation mechanism of the analyzing apparatus or a tip end of a dispensing chip.

A material for the inspection cartridge is not particularly limited as long as it is not a substance inhibiting a reaction for measuring a substance to be inspected. Examples of the material include a polystyrene resin, a polyethylene resin, a polypropylene resin, and a cycloolefin polymer resin.

The laboratory test in the analyzing apparatus for a laboratory test of the present invention includes various inspections such as a biochemical inspection, an immunological inspection, a hematological inspection, or a microbiological inspection. Various methods are selected as the reaction and measurement method, depending on the kind, concentration, and the like of a substance to be inspected. Examples of the method include an enzymatic measurement method, an enzymatic immunoassay, a fluorescence immunoassay, a chemiluminescent immunoassay, an enzymatic chemiluminescent immunoassay, a latex agglutination assay, and a turbidimetric immunoassay.

The transport unit in the analyzing apparatus for a laboratory test of the present invention refers to a unit configured to move and transport an insoluble carrier in which antibodies and the like which specifically bind to a substance to be inspected are immobilized or various reaction solutions required for an inspection. Examples of the transport unit include a handling arm for moving an insoluble carrier, a bound/free separation (B/F separation) mechanism for trapping magnetic fine particles in which antibodies are immobilized, a liquid transport mechanism for transporting liquid into the cartridge by centrifugation, and a conveyer and rotary type transport mechanism for transporting a sample cup or the like.

The dispensing unit in the analyzing apparatus for a laboratory test of the present invention refers to a dispensing mechanism configured to suck/mix/discharge various reagents used in a laboratory test, such as an analyte, a washing solution, and an enzyme labeled antibody solution.

The measuring unit in the analyzing apparatus for a laboratory test of the present invention refers to various detectors used in a laboratory test. Examples of the measuring unit include a photoreceiver such as a photoelectron multiplier used in a chemiluminescent immunoassay or an enzymatic chemiluminescent immunoassay, a light-receiving element such as a photodiode used in a fluorescence immunoassay, a spectral apparatus used in a latex agglutination assay, and an electrode used in a biochemical inspection.

In the analyzing apparatus for a laboratory test of the present invention, at least one of the transport unit, the dispensing unit, and the measuring unit is shared among the inspection cartridges. Sharing as used herein refers to the following: for example, in the case where four inspection cartridges are concurrently processed, the transport unit, the dispensing unit, and the measuring unit are set respectively in the number of one to three instead of providing respective four transport units, dispensing units, and measuring units independently in the apparatus, and those units are used as common units among the inspection cartridges. At least one unit being shared as used herein refers to a state in which, for example, four transport units and four dispensing units are set independently, and one to three measuring units are provided so as to be shared among the cartridges.

In the case where at least one of the transport unit, the dispensing unit, and the measuring unit is shared among the inspection cartridges, the shared unit cannot be used simultaneously by another inspection cartridge. Therefore, it is necessary to create a measurement program by combining reaction and measurement patterns so that the same shared unit is not used simultaneously. The same unit being used simultaneously as used herein also refers to the case programmed so that, in addition to the case programmed so that the same unit is used in at least two processes at a certain time, at least two processes to be performed in the same unit are continuous, and its execution is difficult considering a time required for moving the unit and preparing the processes.

A reaction and measurement pattern in the analyzing apparatus for a laboratory test of the present invention is described hereinafter by way of an example of measurement of a substance to be inspected by an enzymatic chemiluminescent immunoassay.

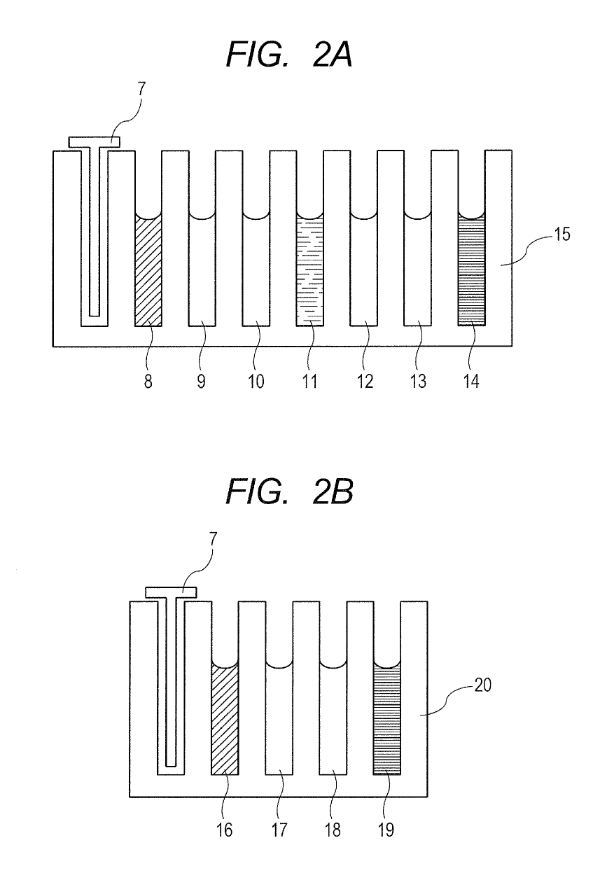

FIG. 2A is a schematic view of an inspection cartridge, for illustrating the sandwich method. An inspection cartridge (container) 15 stores an insoluble carrier 7 in which antibodies which specifically bind to a substance to be inspected are immobilized, an analyte 8 containing the substance to be inspected, washing solutions 9, 10, 12, and 13, an enzyme labeled antibody solution 11 which specifically binds to the substance to be inspected, and a luminescent material 14 which specifically reacts with a labeled enzyme.

An immune reaction and measurement are performed by moving and soaking the insoluble carrier 7 to each reaction tank through use of the transport unit. For example, the insoluble carrier 7 is soaked in the analyte 8 for a predetermined period of time, and the substance to be inspected is allowed to react with antibodies that are immobilized to the insoluble carrier 7. After that, the insoluble carrier 7 is soaked in the washing solutions 9 and 10 for a predetermined period of time to remove an unreacted substance adhering to the insoluble carrier 7. Then, the insoluble carrier 7 is soaked in the enzyme labeled antibody solution 11 for a predetermined period of time, thereby forming a complex of the antibodies that are immobilized to the insoluble carrier 7, the substance to be inspected, and the enzyme labeled antibody. Then, the insoluble carrier 7 is soaked in the washing solutions 12 and 13 for a predetermined period of time to remove the unreacted enzyme labeled antibody 11 adhering to the insoluble carrier 7. Finally, the insoluble carrier 7 is soaked in the luminescent material 14, which specifically reacts with the enzyme, for a predetermined period of time to effect a luminescent reaction between the enzyme and the luminescent material 14. For measurement, light emitted by the luminescent reaction is received by a photoelectron multiplier and measured by a photon counter.

FIG. 2B is a schematic view of an inspection cartridge, for illustrating the competitive measurement method. An inspection cartridge (container) 20 stores an insoluble carrier 7 in which antibodies which specifically bind to a substance to be inspected are immobilized, a mixed solution 16, washing solutions 17 and 18, and a luminescent material 19 which specifically reacts with a labeled enzyme. The mixed solution 16 refers to a mixed solution of an analyte containing the substance to be inspected and enzyme labeled antigens which specifically bind to the immobilized antibodies.

An immune reaction and measurement are performed by moving and soaking the insoluble carrier 7 to each reaction tank through use of the transport unit. For example, the insoluble carrier 7 is soaked in the mixed solution 16 for a predetermined period of time to effect a competitive reaction. The competitive reaction refers to that the substance to be inspected and the enzyme labeled antigens which specifically bind to the immobilized antibodies, which are contained in the mixed solution 16, competitively react with the antibodies which are immobilized to the insoluble carrier 7. After that, the insoluble carrier 7 is soaked in the washing solutions 17 and 18 for a predetermined period of time to remove an unreacted substance adhering to the insoluble carrier 7. Finally, the insoluble carrier 7 is soaked in the luminescent material 19, which specifically reacts with the enzyme, for a predetermined period of time to effect a luminescent reaction. For measurement, light emitted by the luminescent reaction is received by the photoelectron multiplier and measured by the photon counter.

In the sandwich method, measurement is performed through the reaction step with the substance to be inspected, the washing step, the reaction step with the enzyme labeled antibodies, the washing step, and the luminescent reaction step. In the competitive measurement method, measurement is performed through the competitive reaction step, the washing step, and the luminescent reaction step. Reaction times in each step vary depending on, for example, the kind and concentration of the substance to be inspected.

The reaction and measurement pattern in the analyzing apparatus for a laboratory test of the present invention refers to preparing multiple various measurement methods for measuring a substance to be inspected, such as the sandwich method and the competitive method, and identifying them as reaction and measurement patterns. Table 1 is a conceptual diagram of reaction and measurement patterns. Measurement methods required for measuring a substance to be inspected are prepared in advance, each step of a reaction, washing, and luminescence, and a reaction time and number of each step are classified, and pattern Nos. are allocated.

TABLE 1

| Reaction | | | | | | | |
|---|---|---|---|---|---|---|---|
| and | Antigen | | | Enzyme | | | |
| measurement | reaction | | | labeled | | | |
| pattern | Competitive | Washing | Washing | antibody | Washing | Washing | Luminescent |
| (No.) | reaction | (1) | (2) | reaction | (3) | (4) | reaction |
| 1 | 5 minutes | Yes | Yes | 5 minutes | Yes | Yes | 3 minutes |
| 2 | | | | 7.5 minutes | | | |
| 3 | | | | 10 minutes | | | |
| 4 | 7.5 minutes | | | 5 minutes | | | |
| 5 | | | | 7.5 minutes | | | |
| 6 | | | | 10 minutes | | | |
| 7 | 10 minutes | | | 5 minutes | | | |
| 8 | | | | 7.5 minutes | | | |
| 9 | | | | 10 minutes | | | |
| 10 | 5 minutes | | | No | No | No | |
| 11 | 7.5 minutes | | | | | | |
| 12 | 10 minutes | | | | | | |
| . | | | | | | | |
| . | | | | | | | |
| . | | | | | | | |

When producing an inspection cartridge, a pattern suitable for detecting a substance to be inspected is selected from the reaction and measurement patterns shown in Table 1. For example, in the case where the concentration of a substance to be inspected in an analyte is very low, a sensitive measurement method is necessary, and in this case, pattern No. 9 in Table 1 can be considered to be suitable. In the case where the molecular weight of a substance to be inspected is small, the competitive measurement method is suitable, and in this case, pattern Nos. 10 to 12 can be applied. That is, by preparing a large number of those reaction and measurement patterns, measurement of various substances to be inspected can be supported.

In FIGS. 2A and 2B and Table 1, the reaction and measurement patterns are described by way of examples of the sandwich method and the competitive measurement method in an immunological inspection. However, the present invention is not limited to these two kinds of methods. Measurement methods used for various inspections, such as the above-mentioned biochemical inspection and immunological inspection, can be prepared as the reaction and measurement patterns.

Further, the inspection cartridge having one of the reaction and measurement patterns in the analyzing apparatus for a laboratory test of the present invention refers to an inspection cartridge having a reaction and measurement pattern selected when the inspection cartridge is produced. An example of a method of providing the inspection cartridge with a reaction and measurement pattern is that information on a selected reaction and measurement pattern is printed on a bar-code and the bar-code is attached to the inspection cartridge. Alternatively, an IC chip in which information is input may be attached to the inspection cartridge. Moreover, a card or the like describing the above-mentioned pattern information may be enclosed in the inspection cartridge.

The reaction and measurement pattern collecting unit in the analyzing apparatus for a laboratory test of the present invention refers to a collecting unit configured to read information on a reaction and measurement pattern. For example, in the case where pattern information is registered in a bar-code, a bar-code reader is suitable. Further, in the case where pattern information is described in a card or the like, information may be input through use of a card reader or manually.

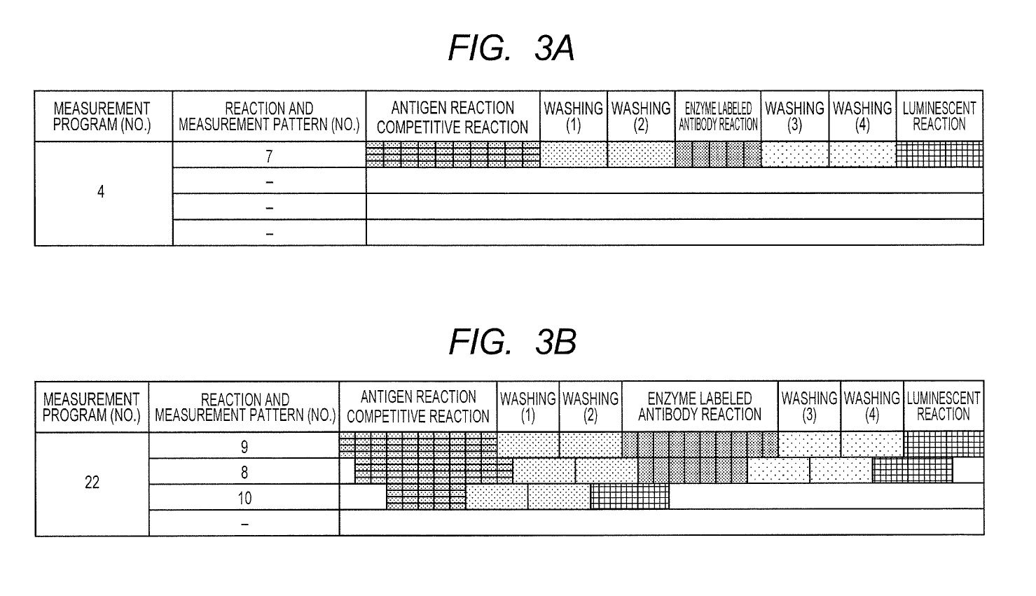

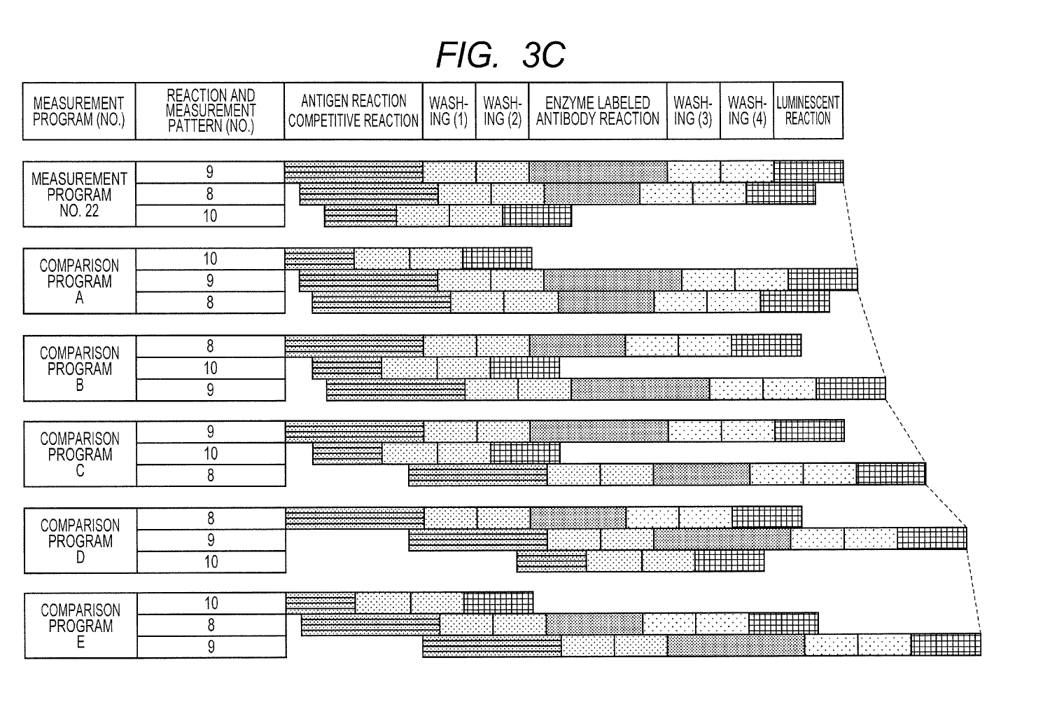

Next, a measurement program in the analyzing apparatus for a laboratory test of the present invention is described with reference to Table 2 and FIGS. 3A to 3C.

It is assumed that there are four kinds of inspection cartridges A, B, C, and D. The four kinds of inspection cartridges are used for measuring different substances to be inspected. It is also assumed that placement regions in which at most four cartridges can be incorporated in one inspection are provided in the analyzing apparatus for a laboratory test.

Table 2 shows reaction and measurement patterns provided in the inspection cartridges A to D. The inspection cartridges A, B, C, and D have reaction and measurement pattern Nos. 10, 9, 8, and 7, respectively. Note that, the detailed conditions of the reaction and measurement pattern Nos. 10, 9, 8, and 7 are as shown in Table 1. For example, the reaction and measurement pattern Nos. 7, 8, and 9 are reaction and measurement patterns using the sandwich method, and the reaction and measurement pattern No. 10 is a reaction and measurement pattern using the competitive measurement method.

TABLE 2

| | Reaction and |
|---|---|
| Inspection | measurement |
| cartridge | pattern |
| A | No. 10 |
| B | No. 9 |
| C | No. 8 |
| D | No. 7 |

Table 3 is a conceptual diagram of a measurement program for concurrently processing the inspection cartridges in all the combinations of the reaction and measurement patterns. The measurement program stores, with respect to the four placement regions in the analyzing apparatus, all the combinations that can be taken by the reaction and measurement pattern Nos. 10, 9, 8, and 7 provided in the inspection cartridges A, B, C, and D. For example, in the case where only one inspection cartridge D is measured, a measurement program No. 4 is applied, and the measurement of the reaction and measurement pattern No. 7 is performed in accordance with the program illustrated in FIG. 3A. Further, in the case where the inspection cartridges A, B, and C are measured, a measurement program No. 22 is applied, and the measurements of the reaction and measurement pattern Nos. 10, 9, and 8 are performed in accordance with a program illustrated in FIG. 3B.

TABLE 3

| Measurement | Combination of reaction and | | | |
|---|---|---|---|---|
| program | measurement patterns | | | |
| No. 1 | 10 | — | — | — |
| No. 2 | 9 | — | — | — |
| No. 3 | 8 | — | — | — |
| No. 4 | 7 | — | — | — |
| No. 5 | 10 | 10 | — | — |
| No. 6 | 10 | 9 | — | — |
| No. 7 | 10 | 8 | — | — |
| No. 8 | 10 | 7 | — | — |
| No. 9 | 9 | 9 | — | — |
| No. 10 | 9 | 8 | — | — |
| No. 11 | 9 | 7 | — | — |
| No. 12 | 8 | 8 | — | — |
| No. 13 | 8 | 7 | — | — |
| No. 14 | 7 | 7 | — | — |
| No. 15 | 10 | 10 | 10 | — |
| No. 16 | 10 | 10 | 9 | — |
| No. 17 | 10 | 10 | 8 | — |
| No. 18 | 10 | 10 | 7 | — |
| No. 19 | 10 | 9 | 9 | — |
| No. 20 | 10 | 8 | 8 | — |
| No. 21 | 10 | 7 | 7 | — |
| No. 22 | 10 | 9 | 8 | — |
| No. 23 | 10 | 9 | 7 | — |
| No. 24 | 10 | 8 | 7 | — |
| No. 25 | 9 | 9 | 9 | — |
| No. 26 | 9 | 9 | 8 | — |
| No. 27 | 9 | 9 | 7 | — |
| No. 28 | 9 | 8 | 8 | — |
| No. 29 | 9 | 7 | 7 | — |
| No. 30 | 9 | 8 | 7 | — |
| No. 31 | 8 | 8 | 8 | — |
| No. 32 | 8 | 8 | 7 | — |
| No. 33 | 8 | 7 | 7 | — |
| No. 34 | 7 | 7 | 7 | — |
| No. 35 | 10 | 10 | 10 | 10 |
| No. 36 | 10 | 10 | 10 | 9 |
| No. 37 | 10 | 10 | 10 | 8 |
| No. 38 | 10 | 10 | 10 | 7 |
| No. 39 | 10 | 10 | 9 | 9 |
| No. 40 | 10 | 10 | 8 | 8 |
| No. 41 | 10 | 10 | 7 | 7 |
| No. 42 | 10 | 9 | 9 | 9 |
| No. 43 | 10 | 8 | 8 | 8 |
| No. 44 | 10 | 7 | 7 | 7 |
| No. 45 | 9 | 9 | 9 | 9 |
| No. 46 | 8 | 8 | 8 | 8 |
| No. 47 | 7 | 7 | 7 | 7 |
| No. 48 | 10 | 10 | 9 | 8 |
| No. 49 | 10 | 10 | 9 | 7 |
| No. 50 | 10 | 10 | 8 | 7 |
| No. 51 | 10 | 9 | 9 | 8 |
| No. 52 | 10 | 9 | 9 | 7 |
| No. 53 | 9 | 9 | 8 | 7 |
| No. 54 | 9 | 8 | 8 | 7 |
| No. 55 | 9 | 8 | 7 | 7 |
| • | • | • | • | • |
| • | • | • | • | • |
| • | • | • | • | • |
| • | • | • | • | • |

Then, an efficient measurement order of the respective cartridges in the measurement program is described.

As described above, in the analyzing apparatus for a laboratory test of the present invention, at least one of the transport unit, the dispensing unit, and the measuring unit is shared among the inspection cartridges. Therefore, there is a limitation for operating each of the units, and occasionally the operations may not be established simultaneously depending on a combination of reaction and measurement patterns. Then, in the measurement program of the present invention, a standby time is provided before start of any reaction and measurement pattern, if required, so that the operations of the respective units may not be overlapped. In this manner, a combination of the reaction and measurement patterns is prevented from failing on a program.

FIG. 3C is a conceptual diagram in which measurement programs caused by a combination of the reaction and measurement pattern Nos. 10, 9, and 8 are listed and compared with each other. There are a total of six measurement programs that can be taken by the above-mentioned three kinds of reaction and measurement patterns. As described above, in the measurement program of the present invention, a standby time is provided so that the operations of the respective units are not overlapped. Therefore, even with a program for measurement of the reaction and measurement pattern Nos. 10, 9, and 8, a time required for the measurement varies depending on the order in which the inspection cartridges are measured. As illustrated in FIG. 3C, it is understood that a measurement program (No. 22) for performing a measurement in the order of the reaction and measurement pattern Nos. 9, 8, and 10 can perform the measurement most efficiently, among the measurement programs that can be taken by a combination of the reaction and measurement pattern Nos. 10, 9, and 8.

Thus, the measurement program in the analyzing apparatus for a laboratory test of the present invention is provided in which a measurement order of inspection cartridges and a standby time are predetermined in advance so that a measurement can be performed most efficiently in a shortest period of time with respect to all the combinations that can be taken by the reaction and measurement patterns provided in the inspection cartridges.

Further, the measurement program storing unit in the present invention is provided with respect to all the combinations of the prepared reaction and measurement patterns. It can store the measurement programs through use of a storage medium.

In this embodiment, the concept of the measurement program is described by way of examples of the four kinds of inspection cartridges A, B, C, and D. However, the present invention is not limited to the combinations of these four kinds. The measurement programs can be stored with respect to all the combinations that can be taken by the prepared reaction and measurement patterns.

The arithmetic processing unit in the analyzing apparatus for a laboratory test of the present invention is a unit configured to identify a combination of reaction and measurement patterns read by a bar-code reader or the like, invoking a measurement program corresponding to the combination by the measurement program storing unit, and causing the measurement program to perform reaction and measurement.

The measurement unit in the analyzing apparatus for a laboratory test of the present invention can have various mechanisms to be carried out by a known analyzing apparatus, such as dispensing, transportation, washing, and photometry. Examples of the mechanisms include a dispensing unit configured to suck a predetermined amount of liquid from one tank in a cartridge and discharging the liquid to another tank, a transport unit configured to transport an insoluble carrier in which antibodies are immobilized, an mixing unit configured to mix contents in the tank, a washing unit configured to wash the insoluble carrier, a measuring unit configured to measure an amount of a reaction product or a label, and a temperature adjusting mechanism for adjusting the temperature of an inspection cartridge.

As described above, the analyzing apparatus for a laboratory test according to the first embodiment of the present invention stores a measurement program programmed in such a manner that, with respect to all the combinations that can be taken by the reaction and measurement patterns provided in the inspection cartridges, the inspection cartridges can be concurrently processed efficiently in one measurement with all the combinations. Therefore, an execution order, an execution time, and an execution interval are predetermined before start of measurement, which makes a time for determining a measurement schedule unnecessary. Further, a program is simple because, for example, a measurement is possible merely by invoking a program corresponding to a combination of inspection cartridges. Therefore, the program can also be applied as an analyzing program for a small analyzing apparatus for a laboratory test aiming at a Point-of-care testing.

### Second Embodiment

An analyzing apparatus of a second embodiment of the present invention is an apparatus for a laboratory test, including at least two placement regions for placing inspection cartridges, the analyzing apparatus being configured to read reaction and measurement patterns provided in the inspection cartridges before the inspection cartridges are placed in the placement regions, and invoke a measurement program corresponding to a combination of the read reaction and measurement patterns, the analyzing apparatus further including an output unit configured to output the order for placing the inspection cartridges in the placement regions.

In order to describe the order for placing the inspection cartridges of the present invention in the placement regions, the case of measuring the inspection cartridges A, B, and C is considered.

As shown in Table 2, the reaction and measurement patterns of the cartridges A, B, and C are Nos. 10, 9, and 8, respectively. Therefore, the measurement program No. 22 is applied. As illustrated in FIG. 3C, the measurement program No. 22, performing a measurement in the order of B, C, and A (Nos. 9, 8, and 10), is a program for performing the measurement most efficiently of the measurement programs that can be taken by a combination of Nos. 10, 9, and 8. However, there are a total of 6 combinations: A→B→C, A→C→B, B→A→C, B→C→A, C→A→B, and C→B→A, which can be taken, when the cartridges A, B, and C are placed in the placement regions. Therefore, in order to perform the program No. 22, it is necessary to place the inspection cartridges in the placement regions in the determined order. That is, the analyzing apparatus for a laboratory test of the second embodiment has a feature of also having the output unit configured to show the order for placing the inspection cartridges in the placement regions.

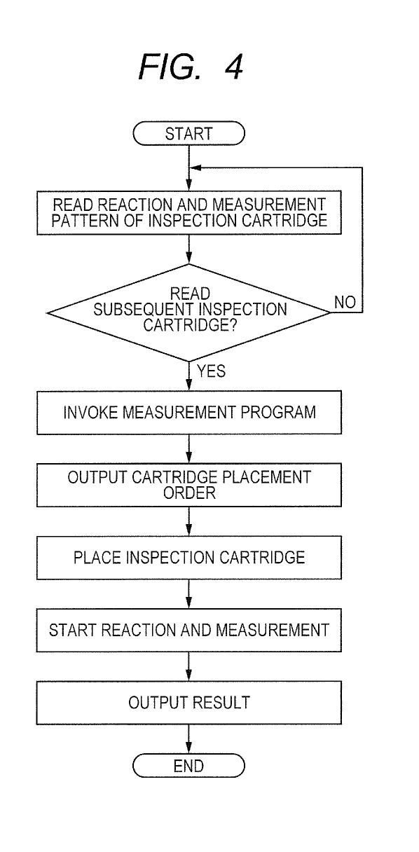

An operation example of the analyzing apparatus of the second embodiment is described hereinafter with reference to a flowchart of FIG. 4. First, a reaction and measurement pattern provided in an inspection cartridge to be measured is read with a bar-code reader or the like. In the case where there is one inspection, a reading operation is ended here, and a measurement program is invoked. In the case where there are multiple inspections, the reading operation of the reaction and measurement pattern is repeated.

Then, a measurement program corresponding to the read reaction and measurement patterns is invoked. The measurement program is invoked from the measurement program storing unit by the arithmetic processing unit. Next, the placement order of the inspection cartridges for performing the measurement program is output. Then, the inspection cartridges are placed in accordance with the output placement order. As the output unit, an external output device such as a personal computer or a liquid crystal monitor contained in the analyzing apparatus can be used. An LED can be provided in an inspection cartridge placement region to designate the placement order through use of light.

Finally, reaction and measurement are started. The measurement result is output to an external output device, a monitor contained in the analyzing apparatus, a printer, or the like.

As described above, the analyzing apparatus for a laboratory test according to the second embodiment of the present invention outputs a placement order of the inspection cartridges, and hence, reduces operation mistakes. The apparatus also can perform an optimum measurement program with a simple operation.

### Third Embodiment

An analyzing apparatus of a third embodiment of the present invention is an apparatus for a laboratory test, including at least two placement regions for placing inspection cartridges, the analyzing apparatus being configured to read reaction and measurement patterns provided in the inspection cartridges after the inspection cartridges are placed in arbitrary placement regions, and invoke a measurement program corresponding to a combination of the read reaction and measurement patterns, the analyzing apparatus further including a mechanism configured to perform reaction and measurement in the order of the inspection cartridges in accordance with the invoked measurement program.

In order to describe the mechanism configured to perform the reaction and measurement in the order from the inspection cartridge in the placement region in accordance with the measurement program of the present invention, the case of measuring the inspection cartridges A, B, and C is considered.

As shown in Table 2, the reaction and measurement patterns of the cartridges A, B, and C are Nos. 10, 9, and 8, respectively. Therefore, the measurement program No. 22 is applied. As illustrated in FIG. 3C, the measurement program No. 22 performing a measurement in the order of B, C, and A (Nos. 9, 8, and 10) is a program for performing the measurement most efficiently of the measurement programs that can be taken by a combination of Nos. 10, 9, and 8. However, there are a total of 6 combinations: A→B→C, A→C→B, B→A→C, B→C→A, C→A→B, and C→B→A, which can be taken, when the cartridges A, B, and C are placed in the placement regions. Therefore, in order to perform the program No. 22, it is necessary to start the reaction and measurement from the cartridge in the determined order.

That is, the analyzing apparatus for a laboratory test of the third embodiment includes a mechanism configured to perform reaction and measurement in the order from the inspection cartridge in accordance with the measurement program, irrespective of the placed region. Thus, even when the inspection cartridges A, B, and C are placed in any of the above-mentioned six combinations, the placement order of the cartridges is identified automatically, and the reaction and measurement can be performed in the order of B, C, and A.

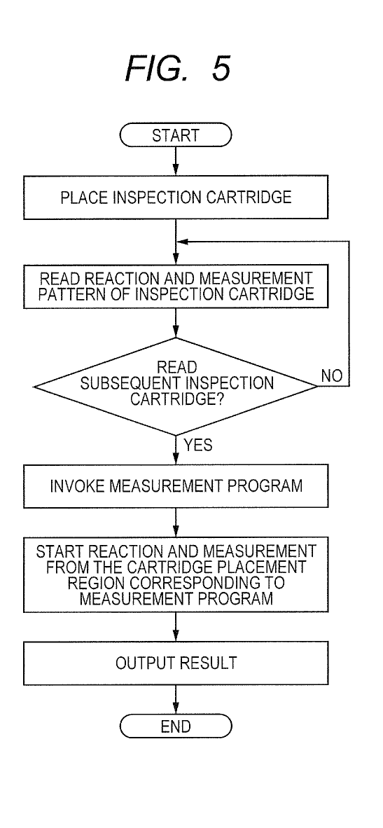

An operation example of the analyzing apparatus of the third embodiment is hereinafter described with reference to a flowchart of FIG. 5. First, inspection cartridges to be measured are placed in any order in the analyzing apparatus for a laboratory test. Then, reaction and measurement patterns provided in the placed inspection cartridges are read automatically with a bar-code reader or the like. At this time, the placement order of the inspection cartridges is also read.

Then, a measurement program corresponding to the read reaction and measurement patterns is invoked. The measurement program is invoked from the measurement program storing unit by the arithmetic processing unit. Finally, reaction and measurement are started from the inspection cartridge in accordance with the invoked measurement program. The measurement result is output to an external output device, a monitor contained in the analyzing apparatus, a printer, or the like.

As described above, in the analyzing apparatus for a laboratory test according to the third embodiment of the present invention, after the arbitrary inspection cartridges are placed in the analyzing apparatus, the reaction and measurement are started from the inspection cartridge in accordance with the measurement program. Therefore, operation mistakes are reduced, and the apparatus can perform an optimum measurement program with an extremely simple operation.

### Fourth Embodiment

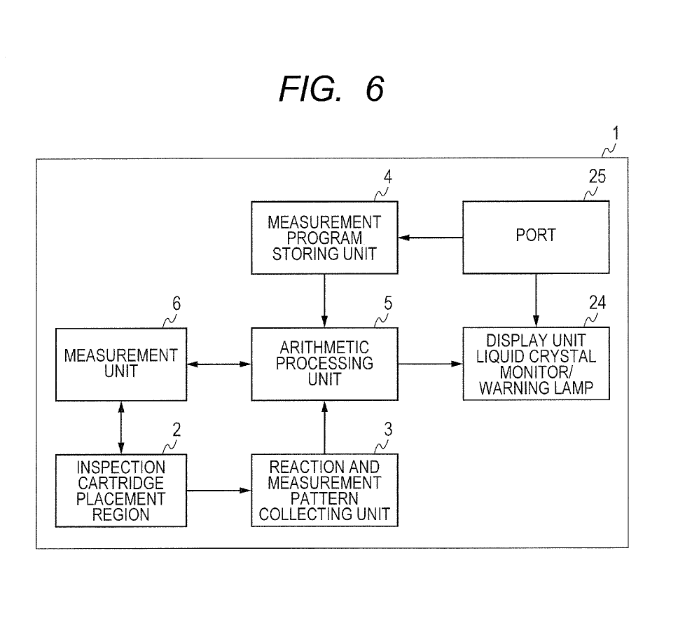

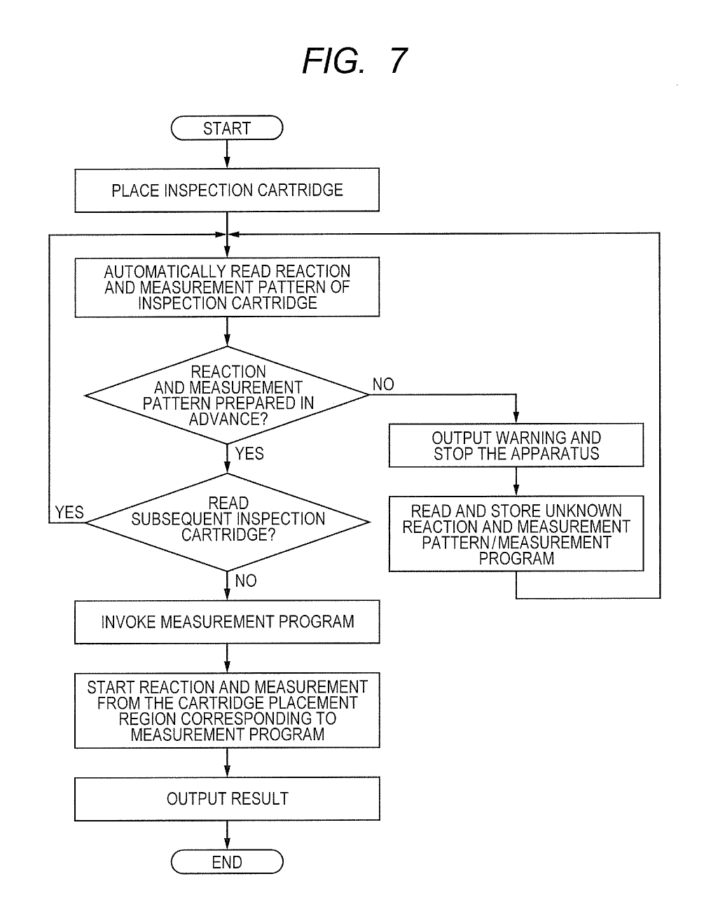

FIG. 6 is a conceptual diagram illustrating a configuration of an analyzing apparatus of a fourth embodiment of the present invention. The analyzing apparatus of the fourth embodiment is an apparatus for a laboratory test, including a mechanism 24 configured to output a warning when an unknown reaction and measurement pattern, which is not prepared in advance, is read from the inspection cartridge, and a mechanism configured to newly read the unknown reaction and measurement pattern and a measurement program for concurrently processing the inspection cartridges in all the combinations of the unknown reaction and measurement pattern and the reaction and measurement patterns prepared in advance.

As described above, in the present invention, a measurement method to be used for various inspections, such as a biochemical inspection and an immunological inspection, can be prepared as a reaction and measurement pattern. However, depending on the properties of a substance to be inspected newly, there may occur a case where a reaction and measurement pattern prepared in advance cannot be adopted. In this case, it is necessary to add a new reaction and measurement pattern suitable for measuring the substance to be inspected.

That is, the analyzing apparatus for a laboratory test of the fourth embodiment can add an unknown reaction and measurement pattern and a measurement program corresponding thereto later. The unknown reaction and measurement pattern refers to a new reaction and measurement pattern not contained in the reaction and measurement patterns prepared in advance.

The measurement program to be newly read in the analyzing apparatus of the fourth embodiment refers to a program programmed in such a manner that all the combinations that can be taken by the reaction and measurement patterns prepared in advance and the unknown reaction and measurement pattern can be concurrently processed in one measurement. For example, in the case of adding an unknown reaction and measurement pattern No. 13 to three kinds of reaction and measurement pattern Nos. 8, 9, and 10 prepared in advance, as shown in Table 4, a measurement program for concurrently processing all the combinations of four reaction and measurement pattern Nos. 8, 9, 10, and 13 is applied.

TABLE 4

| Measurement | Combination of reaction and | | | |
|---|---|---|---|---|
| program | measurement patterns | | | |
| No. 101 | 13 | — | — | — |
| No. 102 | 13 | 13 | — | — |
| No. 103 | 13 | 10 | — | — |
| No. 104 | 13 | 9 | — | — |
| No. 105 | 13 | 8 | — | — |
| No. 106 | 13 | 13 | 13 | — |
| No. 107 | 13 | 13 | 10 | — |
| No. 108 | 13 | 13 | 9 | — |
| No. 109 | 13 | 13 | 8 | — |
| No. 110 | 13 | 10 | 10 | — |
| No. 111 | 13 | 10 | 9 | — |
| No. 112 | 13 | 10 | 8 | — |
| No. 113 | 13 | 9 | 9 | — |
| No. 114 | 13 | 9 | 8 | — |
| No. 115 | 13 | 8 | 8 | — |
| No. 116 | 13 | 13 | 13 | 13 |
| No. 117 | 13 | 13 | 13 | 10 |
| No. 118 | 13 | 13 | 13 | 9 |
| No. 119 | 13 | 13 | 13 | 8 |
| No. 120 | 13 | 13 | 10 | 10 |
| No. 121 | 13 | 13 | 10 | 9 |
| No. 122 | 13 | 13 | 10 | 8 |
| No. 123 | 13 | 13 | 9 | 9 |
| No. 124 | 13 | 13 | 9 | 8 |
| No. 125 | 13 | 13 | 8 | 8 |
| No. 126 | 13 | 10 | 10 | 10 |
| No. 127 | 13 | 10 | 10 | 9 |
| No. 128 | 13 | 10 | 10 | 8 |
| No. 129 | 13 | 10 | 9 | 9 |
| No. 130 | 13 | 10 | 9 | 8 |
| No. 131 | 13 | 10 | 8 | 8 |
| No. 132 | 13 | 9 | 9 | 9 |
| No. 133 | 13 | 9 | 9 | 8 |
| No. 134 | 13 | 9 | 8 | 8 |
| No. 135 | 13 | 8 | 8 | 8 |
| No. 136 | • | • | • | • |
| No. 137 | • | • | • | • |
| No. 138 | • | • | • | • |

An operation example of the analyzing apparatus of the fourth embodiment is described with reference to a flowchart of FIG. 7. First, inspection cartridges are placed in any order in the analyzing apparatus for a laboratory test. Next, reaction and measurement patterns provided in the placed inspection cartridges are read automatically with a bar-code reader or the like. In the case where an unknown reaction and measurement pattern provided in the inspection cartridge is read, a warning is output and the apparatus is stopped. The means configured to output a warning can, for example, output a warning sound. Otherwise, a warning can be displayed visually, including, for example, lighting of a warning lamp and displaying abnormality on a liquid crystal monitor contained in the analyzing apparatus. More preferably, the warning sound and visual means are combined to urge an operator to pay attention by the warning sound and to display a warning content on the liquid crystal monitor.

Next, a measurement program for concurrently processing the inspection cartridges in all the combinations of the unknown reaction and measurement pattern, or the unknown reaction and measurement pattern and the reaction and measurement patterns prepared in advance, are newly read. The means for reading can, for example, be conducted via a port 25. For example, there is a method in which a serial communication port such as RS-232C or RS-422, or a network port such as a LAN is provided in the analyzing apparatus main body, and a new measurement program is transferred and stored via an external connected device such as a personal computer. Further, there is also a method of using a USB port or a slot for a memory card as the port 25. For example, a memory card storing the new measurement program for concurrently processing the inspection cartridges in all the combinations of the reaction and measurement patterns prepared in advance and the unknown reaction and measurement pattern may be connected to the port to store the unknown reaction and measurement pattern and the new measurement program in the analyzing apparatus main body.

Then, a measurement program corresponding to the read reaction and measurement patterns is invoked. The measurement program is invoked from the measurement program storing unit by the arithmetic processing unit. In this case, the newly-added program is invoked. Finally, reaction and measurement are started from the inspection cartridge in the placement region in accordance with the invoked measurement program. The measurement result is output to an external output device, a monitor contained in the analyzing apparatus, a printer, or the like.

As described above, the analyzing apparatus for a laboratory test of the fourth embodiment of the present invention prevents erroneous operation with a wrong measurement program when an unknown reaction and measurement pattern is provided, and it can add an unknown reaction and measurement pattern and a measurement program corresponding thereto, thereby capable of supporting a new inspection cartridge.

### Fifth Embodiment

An analyzing program for a laboratory test of a fifth embodiment of the present invention is a program which stores a measurement program for concurrently processing inspection cartridges in all the combinations of prepared reaction and measurement patterns, the program causing the analyzing apparatus to execute the processes of reading a reaction and measurement pattern of the inspection cartridge in which one of the reaction and measurement patterns supporting various reaction and measurement times and steps prepared in advance is provided, invoking a measurement program corresponding to a combination of the read reaction and measurement patterns, and performing reaction and measurement in accordance with the invoked measurement program.

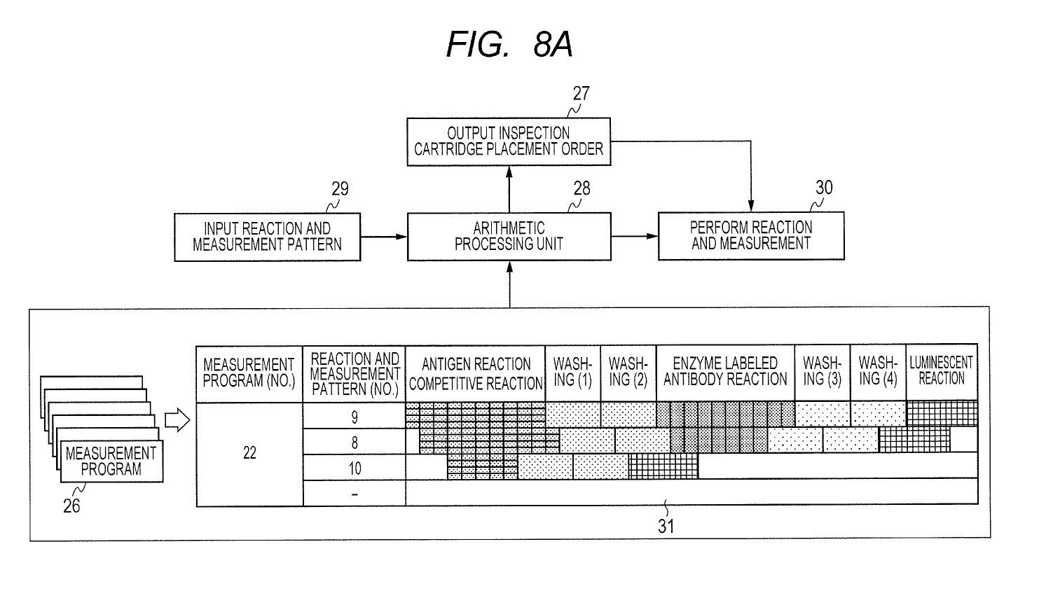

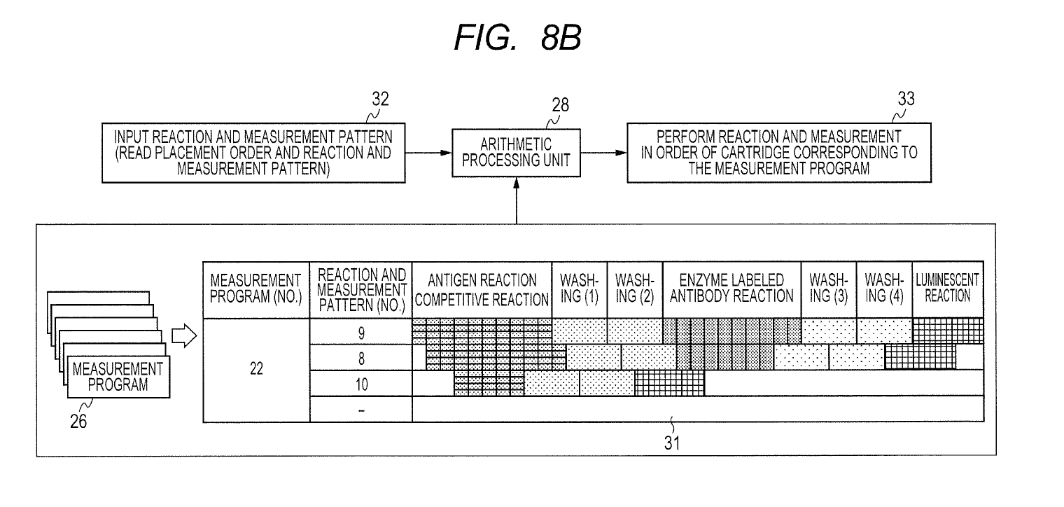

FIG. 8A is a conceptual diagram of a program to be used in the case of outputting a placement order of inspection cartridges to an external connected device such as a personal computer or a liquid crystal monitor contained in the analyzing apparatus. Note that, the case of concurrently measuring the inspection cartridges A, B, and C shown in Table 2 is exemplified here.

First, reaction and measurement patterns provided in the inspection cartridges are read with a bar-code recorder or the like (29). The reaction and measurement patterns of the cartridges A, B, and C are Nos. 10, 9, and 8, respectively, and an arithmetic processing unit (28) invokes a measurement program (31) corresponding to a combination of the input measurement patterns from measurement programs (26) for concurrently processing the inspection cartridges in all the combinations of the reaction and measurement patterns. In this case, a measurement program No. 22 for concurrently processing the reaction and measurement pattern Nos. 10, 9, and 8 is invoked. Further, as illustrated in FIG. 3B, an order for performing reaction and measurement of the inspection cartridges is incorporated in the invoked measurement program, and in accordance with the incorporated order, a placement order of the inspection cartridges is output (27). The measurement program No. 22 is a program for starting reaction and measurement in the order of the reaction and measurement pattern Nos. 9, 8, and 10, and the placement order is output to a liquid crystal monitor or the like. An operator places the inspection cartridges in accordance with the output placement order. After that, reaction and measurement are performed in accordance with the invoked measurement program No. 22 (30).

FIG. 8B is a conceptual diagram of a program to be used in the case of starting reaction and measurement after placing the inspection cartridges in an arbitrary order. Note that, the case of concurrently measuring the inspection cartridges A, B, and C shown in Table 2 is also exemplified here.

First, inspection cartridges are placed in the analyzing apparatus for a laboratory test in an arbitrary order. In this case, it is assumed that the inspection cartridges are placed in the order of A, B, and C. Next, the reaction and measurement pattern Nos. 10, 9, and 8 provided in the inspection cartridges are read with a bar-code reader or the like contained in the analyzing apparatus (32). Further, at this time, a placement order (reaction and measurement pattern Nos. 10, 9, and 8) of the cartridges placed in the analyzing apparatus is also read. The arithmetic processing unit (28) invokes a measurement program (31) corresponding to a combination of the input reaction and measurement patterns from the measurement programs (26) for concurrently processing the inspection cartridges in all the combinations of the reaction and measurement patterns. In this case, the measurement program No. 22 for concurrently processing the reaction and measurement pattern Nos. 10, 9, and 8 is invoked. Further, as illustrated in FIG. 3B, an order (reaction and measurement pattern Nos. 9, 8, and 10) for performing reaction and measurement of the inspection cartridges is incorporated in the invoked measurement program, and reaction and measurement are performed in the order of the inspection cartridges corresponding to the measurement program (33). In this case, reaction and measurement are performed in the order of the cartridges B, C, and A.

As described above, the analyzing program for a laboratory test of the fifth embodiment previously stores measurement programs programmed in such a manner that the inspection cartridges can be measured concurrently in all the combinations that can be taken by the reaction and measurement patterns provided in the inspection cartridges. Further, the analyzing program for a laboratory test of the fifth embodiment stores a program for outputting a placement order of the inspection cartridges corresponding to a measurement program and a program for performing reaction and measurement in the order of the inspection cartridges corresponding to the measurement program.

Therefore, an execution order, an execution time, and an execution interval are determined before the start of measurement, which makes a time for determining a measurement schedule unnecessary. Further, the program is simple because, for example, a measurement is possible merely by invoking a program corresponding to a combination of inspection cartridges. Therefore, the program can also be applied for a small analyzing apparatus for a laboratory test aiming at a Point-of-care testing.

### EXAMPLES

The present invention is hereinafter described more specifically by way of examples. Note that, the following examples merely exemplify the present invention, and the scope of the present invention is not limited by the following examples at all.

(1) Analyzing Apparatus for Laboratory Test

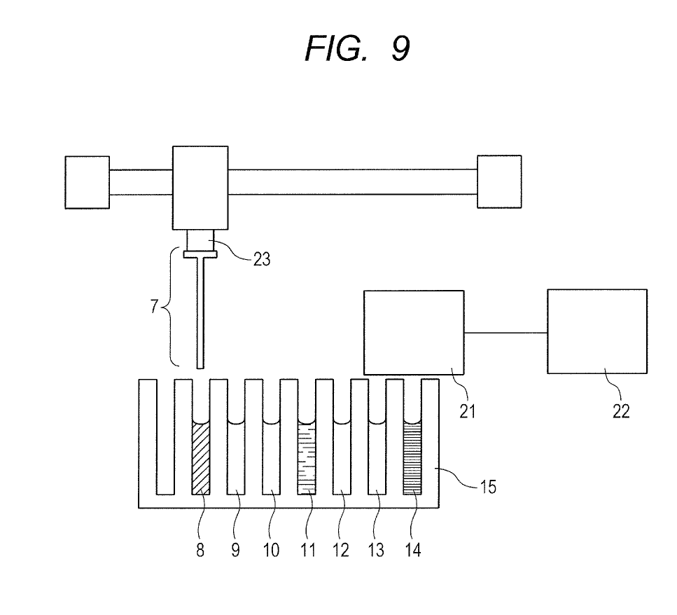

FIG. 9 is a conceptual diagram of a measurement unit in the analyzing apparatus for a laboratory test used in the examples. As illustrated in FIG. 9, the inspection cartridge 15 similar to that of FIG. 2A is placed in the measurement unit, and the measurement unit includes a photoelectron multiplier 21, a photon counter 22, and a handling arm 23 for transporting an insoluble carrier.

As illustrated in FIG. 9, the photoelectron multiplier 21 is arranged above the cartridge container 15 so as to receive a luminescent reaction occurring during measurement of a substance to be inspected.

Further, the photon counter 22 is placed so as to measure a signal from the photoelectron multiplier 21 and it is connected to a personal computer.

As illustrated in FIG. 9, the handling arm 23 is used for transporting an insoluble carrier 7 and it is placed above the cartridge container 15.

(2) Production of Insoluble Carrier

The insoluble carrier 7 illustrated in FIG. 9 was produced by subjecting a polystyrene resin to injection molding. A plate-shaped region in an upper part of the insoluble carrier 7 was a plate-shaped region to be used at a time of transportation by the handling arm 23, and a diameter of the plate-shaped region was set to 12 mm and a thickness thereof was set to 1.5 mm. Further, a columnar region of the insoluble carrier 7 is used for immobilizing antibodies which specifically bind to a substance to be inspected, and a diameter of the columnar region was set to 0.7 mm and a length thereof was set to 40 mm.

(3) Production of Inspection Cartridge Container

The container 15 illustrated in FIG. 9 was produced by subjecting a polypropylene resin to injection molding. A diameter of each tank was set to 2.6 mm and a depth thereof was set to 41 mm. Further, an interval between adjacent holes was set to 18 mm.

(4) Method of Transporting Insoluble Carrier

A tubular jig having a cylindrical tip end made of silicone rubber and a tube were mounted to a tip end of the handling arm 23. A magnetic valve and an air pump were mounted to an end of the tube. A negative pressure was brought into the tube with the air pump, and the insoluble carrier 7 was allowed to be lifted or released through the plate-shaped region by turning on/off the magnetic valve. This mechanism enabled the insoluble carrier 7 to move from a reaction tank to another reaction tank of the cartridge container 15.

(5) Immobilization of IL6 Antibodies to Insoluble Carrier

IL6 antibodies (produced by BioLegend, Inc.) were diluted to 10 μg/ml with phosphate buffered saline (pH 7.2) and dispensed by 100 μl to a container for immobilizing antibodies. After that, the columnar region of the insoluble carrier 7 was soaked in the solution and allowed to stand around the clock at 4° C.

Next, the insoluble carrier 7 was removed, and the surface thereof was washed with phosphate buffered saline (pH 7.2).

Then, Bovine Serum Albumin (produced by Sigma

Corporation) as a blocking agent was diluted to 5% with phosphate buffered saline (pH 7.2), and the solution was dispensed by 100 μl to the container for immobilizing antibodies. After that, the columnar region of the insoluble carrier 7 was soaked in the solution and allowed to stand at room temperature for 2 hours.

After that, the insoluble carrier 7 was removed, and the surface thereof was washed with phosphate buffered saline (pH 7.2).

Then, Sucrose was diluted to 5% with phosphate buffered saline (pH 7.2), and the solution was dispensed by 100 μl to the container for immobilizing antibodies. After that, the columnar region of the insoluble carrier 7 was soaked in the solution and allowed to stand at room temperature for 2 hours.

Finally, the insoluble carrier 7 was removed and dried, and stored at 4° C.

(6) Labeling of HRP to IL6 Antibodies

Enzyme labeling to IL6 antibodies (produced by BioLegend, Inc.) was performed in accordance with a manufacturer protocol through use of Peroxidase Labeling Kit-NH₂ (trade name, produced by DOJINDO LABORATORIES).

Next, the enzyme-labeled IL6 antibodies were adjusted to 1.0 μg/ml through use of 1% BSA-containing phosphate buffered saline (pH 7.2) and stored at 4° C.

(7) Immobilization of CRP Antibodies to Insoluble Carrier

CRP antibodies (produced by HyTest, Ltd.) were diluted to 10 μg/ml with phosphate buffered saline (pH 7.2) and dispensed by 100 μl to the container for immobilizing antibodies. After that, the columnar region of the insoluble carrier 7 was soaked in the solution and allowed to stand around the clock at 4° C.

Next, the insoluble carrier 7 was removed, and the surface thereof was washed with phosphate buffered saline (pH 7.2).

Then, Bovine Serum Albumin (produced by Sigma

Corporation) as a blocking agent was diluted to 5% with phosphate buffered saline (pH 7.2), and the solution was dispensed by 100 μl to the container for immobilizing antibodies. After that, the columnar region of the insoluble carrier 7 was soaked in the solution and allowed to stand at room temperature for 2 hours.

After that, the insoluble carrier 7 was removed, and the surface thereof was washed with phosphate buffered saline (pH 7.2).

Then, Sucrose was diluted to 5% with phosphate buffered saline (pH 7.2), and the solution was dispensed by 100 μl to the container for immobilizing antibodies. After that, the columnar region of the insoluble carrier 7 was soaked in the solution and allowed to stand at room temperature for 2 hours.

Finally, the insoluble carrier 7 was removed and dried, and stored at 4° C.

(8) Labeling of HRP to CRP

Enzyme labeling to recombinant CRP (produced by Oriental Yeast Co., Ltd.) was performed in accordance with a manufacturer protocol through use of Peroxidase Labeling Kit-NH₂ (trade name, produced by DOJINDO LABORATORIES).

Next, the enzyme-labeled CRP was adjusted to 1.0 μg/ml through use of 1% BSA-containing phosphate buffered saline (pH 7.2) and stored at 4° C. until use.

(9) Immobilization of HCG Antibodies to Insoluble Carrier

Human chorionic gonadotropin (HCG) antibodies (produced by Medix Biochemica, Ltd.) were diluted to 10 μg/ml with phosphate buffered saline (pH 7.2) and dispensed by 100 μl to the container for immobilizing antibodies. After that, the columnar region of the insoluble carrier 7 was soaked in the solution and allowed to stand around the clock at 4° C.

Next, the insoluble carrier 7 was removed, and the surface thereof was washed with phosphate buffered saline (pH 7.2).

Then, Bovine Serum Albumin (produced by Sigma Corporation) as a blocking agent was diluted to 5% with phosphate buffered saline (pH 7.2), and the solution was dispensed by 100 μl to the container for immobilizing antibodies. After that, the columnar region of the insoluble carrier 7 was soaked in the solution and allowed to stand at room temperature for 2 hours.

After that, the insoluble carrier 7 was removed, and the surface thereof was washed with phosphate buffered saline (pH 7.2).

Then, Sucrose was diluted to 5% with phosphate buffered saline (pH 7.2), and the solution was dispensed by 100 μl to the container for immobilizing antibodies. After that, the columnar region of the insoluble carrier 7 was soaked in the solution and allowed to stand at room temperature for 2 hours.

Finally, the insoluble carrier 7 was removed and dried, and stored at 4° C.

(10) Labeling of HRP to Human FSH α-Subunit Antibodies

Enzyme labeling to human follicle stimulating hormone (FSH) α-subunit antibodies (produced by Medix Biochemica, Ltd., FSH α-subunit is immunologically the same as HCG α-subunit) was performed in accordance with a manufacturer protocol through use of Peroxidase Labeling Kit-NH₂ (trade name, produced by DOJINDO LABORATORIES).

Next, the enzyme-labeled human FSH α-subunit antibodies were adjusted to 1.0 μg/ml through use of 1% BSA-containing phosphate buffered saline (pH 7.2) and stored at 4° C.

(11) Filling of Reagent for Measurement to Inspection Cartridge

For measurement of IL6, the inspection cartridge container 15 illustrated in FIG. 2A is used. The insoluble carrier 7 in which the IL6 antibodies are immobilized is inserted at a predetermined position of the inspection cartridge container. Then, Tween 20-containing phosphate buffered saline (pH 7.2) as a washing solution is dispensed by 115 μl to washing tanks 9, 10, 12, and 13. Then, 100 μl of the HRP-labeled IL6 antibodies adjusted to 1.0 μg/ml is dispensed to a reaction tank 11. Finally, 100 μl of a chemiluminescent reagent (produced by Thermo Fisher Scientific K.K.) is dispensed to a reaction tank 14. Thus, an IL6 inspection cartridge is obtained. Note that, when the inspection cartridge is used, 100 μl of an analyte containing a substance to be inspected is dispensed to a reaction tank 8.

For measurement of CRP, the inspection cartridge container 20 illustrated in FIG. 2B is used. The insoluble carrier 7 in which the CRP antibodies are immobilized is inserted at a predetermined position of the inspection cartridge container. Then, Tween 20-containing phosphate buffered saline (pH 7.2) as a washing solution is dispensed by 115 μl to washing tanks 17 and 18. Finally, 100 μl of a chemiluminescent reagent (produced by Thermo Fisher Scientific K.K.) is dispensed to a reaction tank 19. Thus, a CRP inspection cartridge is obtained. Note that, when the inspection cartridge is used, a mixed solution of HRP-labeled CRP (50 μl) adjusted to 1.0 μg/ml and an analyte (50 μl) containing a substance to be inspected is dispensed to a reaction tank 16.

For measurement of HCG, the inspection cartridge container 15 illustrated in FIG. 2A is used. The insoluble carrier 7 in which the HCG antibodies are immobilized is inserted at a predetermined position of the inspection cartridge container. Then, Tween 20-containing phosphate buffered saline (pH 7.2) as a washing solution is dispensed by 115 μl to the washing tanks 9, 10, 12, and 13. Then, 100 μl of the HRP-labeled human FSH α-subunit antibodies adjusted to 1.0 μg/ml is dispensed to the reaction tank 11. Finally, 100 μl of a chemiluminescent reagent (produced by Thermo Fisher Scientific K.K.) is dispensed to the reaction tank 14. Thus, an HCG inspection cartridge is obtained. Note that, when the inspection cartridge is used, 100 μl of an analyte containing a substance to be inspected is dispensed to the reaction tank 8.

### Example 1

### Measurement of Three Kinds of Inspection Cartridges

For measurement of IL6, CRP, and HCG, the analyzing apparatus for a laboratory test illustrated in FIG. 9 is used. An IL6 inspection cartridge is produced based on the reaction and measurement pattern No. 9 (reaction time with an analyte: 10 minutes, reaction time with HRP-labeled IL6 antibodies: 10 minutes, washing after each step: twice, luminescent reaction time: 3 minutes). A CRP inspection cartridge is produced based on the reaction and measurement pattern No. 10 (competitive reaction time: 5 minutes, washing: twice, luminescent reaction time: 3 minutes). Further, an HCG inspection cartridge is produced based on the reaction and measurement pattern No. 8 (reaction time with an analyte: 10 minutes, reaction time with HRP-labeled human FSH α-subunit antibodies: 7.5 minutes, washing after each step: twice, luminescent reaction time: 3 minutes).

First, the reaction and measurement pattern Nos. 8, 9, and 10 of the HCG, IL6, and CRP are input to the analyzing apparatus. In this case, the reaction and measurement pattern Nos. 8, 9, and 10 are input manually through use of control software of a personal computer connected externally. Then, a measurement program corresponding to the combination is invoked from the measurement program storing unit. In this case, the measurement program No. 22 is invoked. Finally, the inspection cartridge Nos. 9, 8, and 10 are placed in the analyzing apparatus in this order, and reaction and measurement are started. The measurement is completed in about 40 minutes, and the three kinds of inspection cartridges can be concurrently processed.

As described above, in the analyzing device for a laboratory test of the present invention, an execution order, an execution time, and an execution interval are determined before the start of measurement, which makes a time for determining a measurement schedule unnecessary. Further, a program is simple because, for example, a measurement is possible merely by invoking a program corresponding to a combination of inspection cartridges. Therefore, the program can also be applied as an analyzing program for a small analyzing apparatus for a laboratory test aiming at a Point-of-care testing.

### Example 2

### Measurement of Three Kinds of Inspection Cartridges by Output of Cartridge Placement Order

For measurement of IL6, CRP, and HCG, the analyzing apparatus for a laboratory test illustrated in FIG. 9 is used. A bar-code provided in the IL6 inspection cartridge stores information on the reaction and measurement pattern No. 9 (reaction time with an analyte: 10 minutes, reaction time with HRP-labeled IL6 antibodies: 10 minutes, washing after each step: twice, luminescent reaction time: 3 minutes). A bar-code provided in the CRP inspection cartridge stores information on the reaction and measurement pattern No. 10 (competitive reaction time: 5 minutes, washing: twice, luminescent reaction time: 3 minutes). A bar-code provided in the HCG inspection cartridge stores information on the reaction and measurement pattern No. 8 (reaction time with an analyte: 10 minutes, reaction time with HRP-labeled human FSH α-subunit antibodies: 7.5 minutes, washing after each step: twice, luminescent reaction time: 3 minutes).

First, respective pieces of reaction and measurement pattern information (Nos. 8, 9, and 10) provided in the HCG, IL6, and CRP inspection cartridges are read with a bar-code reader connected to the analyzing apparatus. Next, a measurement program corresponding to the combination is invoked from the measurement program storing unit. In this case, the measurement program No. 22 is invoked. Next, a placement order of the inspection cartridges is displayed on an output screen of the analyzing apparatus, and hence, the inspection cartridges are incorporated into the analyzing apparatus in accordance with the order. In this case, the respective cartridges are placed in the order of IL6, HCG, and CRP. Finally, reaction and measurement are started. The measurement is completed in about 40 minutes, and the three kinds of inspection cartridges can be concurrently processed.

As described above, in the analyzing apparatus for a laboratory test according to the second embodiment of the present invention, the placement order of the inspection cartridges is output, and hence, an optimum measurement program can be performed with a simple operation.

### Example 3

### Measurement of Three Kinds of Inspection Cartridges by Automatic Recognition of Reaction and Measurement Patterns

For measurement of IL6, CRP, and HCG, the analyzing apparatus for a laboratory test illustrated in FIG. 9 is used. A bar-code provided in the IL6 inspection cartridge stores information on the reaction and measurement pattern No. 9 (reaction time with an analyte: 10 minutes, reaction time with HRP-labeled IL6 antibodies: 10 minutes, washing after each step: twice, luminescent reaction time: 3 minutes). A bar-code provided in the CRP inspection cartridge stores information on the reaction and measurement pattern No. 10 (competitive reaction time: 5 minutes, washing: twice, luminescent reaction time: 3 minutes). A bar-code provided in the HCG inspection cartridge stores information on the reaction and measurement pattern No. 8 (reaction time with an analyte: 10 minutes, reaction time with HRP-labeled human FSH α-subunit antibodies: 7.5 minutes, washing after each step: twice, luminescent reaction time: 3 minutes).

First, the IL6, CRP, and HCG inspection cartridges are placed in the analyzing apparatus in an arbitrary order. In this case, the HCG, IL6, and CRP inspection cartridges are placed in this order. Then, respective pieces of the reaction and measurement pattern information (Nos. 8, 9, and 10) provided in the inspection cartridges are read automatically with a bar-code reader connected to the analyzing apparatus. Then, a measurement program corresponding to the combination is invoked from the measurement program storing unit. In this case, the measurement program No. 22 is invoked. Finally, reaction and measurement are started. In this case, reaction and measurement are started in the order of IL6, HCG, and CRP in accordance with the measurement program No. 22. The measurement is completed in about 40 minutes, and the three kinds of inspection cartridges can be concurrently processed.

As described above, in the analyzing apparatus for a laboratory test according to the third embodiment of the present invention, after arbitrary inspection cartridges are placed in the analyzing apparatus, reaction and measurement are started from the inspection cartridge in accordance with the measurement program, and hence, the analyzing apparatus is simple and has a small number of operation errors.

### Example 4

### Measurement of Inspection Cartridge in which Unknown Reaction and Measurement Pattern is Provided

For measurement of IL6, CRP, and HCG, the analyzing apparatus for a laboratory test illustrated in FIG. 9 is used. A bar-code provided in the IL6 inspection cartridge stores information on the reaction and measurement pattern No. 9 (reaction time with an analyte: 10 minutes, reaction time with HRP-labeled IL6 antibodies: 10 minutes, washing after each step: twice, luminescent reaction time: 3 minutes). A bar-code provided in the CRP inspection cartridge stores information on the reaction and measurement pattern No. 10 (competitive reaction time: 5 minutes, washing: twice, luminescent reaction time: 3 minutes). A bar-code provided in the HCG inspection cartridge stores information on the unknown reaction and measurement pattern No. 13 (reaction time with an analyte: 12 minutes, reaction time with HRP-labeled human FSH α-subunit antibodies: 12 minutes, washing after each step: twice, luminescent reaction time: 3 minutes).

First, the IL6, CRP, and HCG inspection cartridges are placed in the analyzing apparatus in an arbitrary order. In this case, the IL6, CRP, and HCG inspection cartridges are placed in this order. Then, respective pieces of the reaction and measurement pattern information (Nos. 9, 10, and 13) provided in the inspection cartridges are read automatically with a bar-code reader connected to the analyzing apparatus.

In this case, the reaction and measurement pattern No. 13 is an unknown reaction and measurement pattern, and hence, the analyzing apparatus outputs a warning and stops.

Then, a measurement program for concurrently processing the inspection cartridges in all the combinations of the unknown reaction and measurement pattern No. 13 and the three kinds of reaction and measurement pattern Nos. 9, 10, and 13 is transferred to the analyzing apparatus. As a result of the transfer, the reaction and measurement pattern information on the unknown reaction and measurement pattern No. 13 and the measurement program for concurrently processing the inspection cartridges in all the combinations of the three kinds of reaction and measurement pattern Nos. 9, 10, and 13 are stored in the measurement program storing unit. Therefore, when reading is started again, the respective pieces of the reaction and measurement pattern information (Nos. 9, 10, 13) provided in the inspection cartridges are read without outputting a warning.

Then, a measurement program corresponding to the combination is invoked from the measurement program storing unit. In this case, the measurement program No. 111 (program in which measurement of the three kinds of reaction and measurement pattern Nos. 9, 10, and 13 is performed in the order of Nos. 13, 9, and 10) is invoked. Then, reaction and measurement are started. The measurement is completed in about 45 minutes, and the three kinds of inspection cartridges can be concurrently processed.

As described above, the analyzing apparatus for a laboratory test according to the fourth embodiment of the present invention is not operated erroneously with a wrong measurement program when an unknown reaction and measurement pattern is input, and it can add the unknown reaction and measurement pattern and a measurement program corresponding thereto, thereby capable of supporting a new inspection cartridge.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-270513, filed Dec. 9, 2011, which is hereby incorporated by reference herein in its entirety.

1. An analyzing apparatus for a laboratory test, which is configured to concurrently process multiple inspection cartridges, each cartridge having a reaction and measurement pattern which is formed of a combination of a reaction and measurement time and a step, the analyzing apparatus comprising:
at least one of transport units, dispensing units, and measuring units, in which at least one of the transport units, the dispensing units, and the measuring units is shared among the multiple inspection cartridges;
a placement region for the multiple inspection cartridges;
a measurement program storing unit configured to store a measurement program for concurrently processing the multiple inspection cartridges so that the at least one units shared among the multiple inspection cartridges is not used simultaneously by the multiple inspection cartridges regarding all combinations of prepared reaction and measurement patterns;
a reaction and measurement pattern collecting unit configured to read the reaction and measurement patterns of the multiple inspection cartridges;
an arithmetic processing unit configured to invoke a measurement program corresponding to a combination of the read reaction and measurement patterns; and
a measurement unit having a mechanism configured to perform reaction and measurement in accordance with the measurement program.

2. An analyzing apparatus for a laboratory test according to claim 1, further comprising an output unit configured to output an order for placing the multiple inspection cartridges in the placement region,
wherein the reaction and measurement pattern collecting unit reads the reaction and measurement patterns provided in the multiple inspection cartridges before the multiple inspection cartridges are placed in the placement region, and
wherein the output unit outputs the order for placing the multiple inspection cartridges in the placement region, the order determined for the measurement program, corresponding to the combination of the read reaction and measurement patterns invoked by the arithmetic processing unit, to be performed.

3. An analyzing apparatus for a laboratory test according to claim 1, further comprising a mechanism configured to perform reaction and measurement in an order of the multiple inspection cartridges corresponding to the invoked measurement program irrespective of which placement region each of the multiple inspection cartridges is placed,
wherein the reaction and measurement pattern collecting unit reads the reaction and measurement patterns provided in the multiple inspection cartridges after the each of the multiple inspection cartridges is placed in an arbitrary placement region, and
wherein the reaction and the measurement are performed in accordance with the measurement program corresponding to the combination of the read reaction and measurement patterns invoked by the arithmetic processing unit.

4. An analyzing apparatus for a laboratory test according to claim 1, further comprising:
a mechanism configured to output a warning when the reaction and measurement pattern collecting unit reads an unknown reaction and measurement pattern; and
a mechanism configured to newly read a measurement program for concurrently processing the multiple inspection cartridges so that the at least one units shared among the multiple inspection cartridges is not used simultaneously by the multiple inspection cartridges regarding all combinations of the unknown reaction and measurement pattern and the reaction and measurement patterns prepared in advance.

5. An analyzing apparatus for a laboratory test according to claim 1, wherein the measurement program comprises a program in which a measurement order and a standby time of the multiple inspection cartridges are determined.

6. An analyzing apparatus for a laboratory test according to claim 5, wherein the measurement program comprises a program in which the measurement order and the standby time of the multiple inspection cartridges are determined so that a time required for measuring all the multiple inspection cartridges becomes shortest.

7. A non-transitory computer readable medium storing an analyzing program for causing a computer to execute steps of a laboratory test for concurrently processing multiple inspection cartridges each having a reaction and measurement pattern formed of a combination of a reaction and measurement time and a step in an analyzing apparatus for a laboratory test, the analyzing apparatus including at least one of transport units, dispensing units, and measuring units, and a placement region for the multiple inspection cartridges, at least one of the transport units, the dispensing units, and the measuring units being shared among the multiple inspection cartridges,
the analyzing program storing a measurement program for concurrently processing the multiple inspection cartridges so that the at least one units shared among the multiple inspection cartridges is not used simultaneously by the multiple inspection cartridges regarding all combinations of prepared reaction and measurement patterns,
the analyzing program causing the analyzing apparatus to execute the processes of:
reading the reaction and measurement patterns of the multiple inspection cartridges in each of which one of the reaction and measurement patterns corresponding to various reaction and measurement times and steps prepared in advance is provided;
invoking a measurement program corresponding to a combination of the read reaction and measurement patterns; and
performing reaction and measurement in accordance with the invoked measurement program.

8. A non-transitory computer readable medium according to claim 7, further causing the analyzing apparatus to execute the processes of:
reading the reaction and measurement patterns provided in the multiple inspection cartridges before the multiple inspection cartridges are placed in the placement region; and
outputting an order for placing the multiple inspection cartridges in the placement region of the analyzing apparatus for a laboratory test for performing the invoked measurement program corresponding to the combination of the read reaction and measurement patterns.

9. A non-transitory computer readable medium according to claim 7, further causing the analyzing apparatus to execute the processes of:
reading the reaction and measurement patterns provided in the multiple inspection cartridges after each of the multiple inspection cartridges are placed in an arbitrary placement region of the analyzing apparatus for a laboratory test; and
enabling the reaction and the measurement to be performed in accordance with the invoked measurement program corresponding to the combination of the read reaction and measurement patterns irrespective of which placement region the each of the multiple inspection cartridges is placed.

10. A non-transitory computer readable medium according to claim 7, wherein the measurement program comprises a program in which a measurement order and a standby time of the multiple inspection cartridges are determined.

11. A non-transitory computer readable medium according to claim 10, wherein the measurement program comprises a program in which the measurement order and the standby time of the multiple inspection cartridges are determined so that a time required for measuring all the multiple inspection cartridges becomes shortest.
